(19) United States
(12) Patent Application Publication
(10) Pub. No.: US 2026/0363197 A1
(43) Pub. Date: Nov. 19, 2026

(54) AUTOMATIC CAT LITTER ADDING STRUCTURE

(71) Applicant: SHENZHEN QIANHAI HOMERUN SMART TECHNOLOGY CO., LTD., Guangdong (CN)

(72) Inventor: Zhence WU, Guangdong (CN)

(21) Appl. No.: 19/144,219

(22) PCT Filed: Aug. 29, 2023
(86) PCT No.: PCT/CN2023/115402

§ 371 Date: Jun. 27, 2025

(30) Foreign Application Priority Data
Mar. 13, 2023 (CN) 202320534612.3

(51) Int. Cl. A01K 1/01

(52) U.S. Cl. CPC A01K 1/0107

(57) ABSTRACT

An automatic cat litter adding structure includes a litter storage bin and a litter adding device. The litter storage bin is provided with a litter bin discharge port; the litter adding device includes a device main body, a feeding screw and a driver; the device main body is provided with a screw cavity, and a litter adding intake port and a cat litter adding discharge port which are in communication with the screw cavity; the litter bin discharge port is in communication with the cat adding intake port; the feeding screw is mounted in the screw cavity; and the driver is connected to the feeding screw and is configured to drive the feeding screw to rotate.

The present application claims the priority to Chinese Patent Application No. 202320534612.3, titled “AUTOMATIC CAT LITTER ADDING STRUCTURE”, filed with the China National Intellectual Property Administration on Mar. 13, 2023, which is incorporated herein by reference in its entirety.

### FIELD

The present disclosure relates to the technical field of pet supplies, and in particular to an automatic cat litter adding structure.

### BACKGROUND

In recent years, the pet market has been growing rapidly due to the increasing number of pet owners. Pets can provide emotional comfort, helping to relieve anxiety, loneliness, and other negative emotions. Among them, cats are one of the most commonly owned pets.

Cats typically require cat litter for urination and defecation, and the cat litter is gradually consumed during use. If there is too little litter, the waste may easily stick to the bottom of the litter box, making it dirtier, or the litter may fail to cover odors. Additionally, the cat litter deteriorates over time. Therefore, it is necessary to frequently replenish the cat litter. At present, cat litter is mostly refilled manually, making timely and automatic replenishment difficult.

### SUMMARY

In view of this, an object of the present disclosure is to provide an automatic cat litter adding structure, which enables quantitative addition of cat litter and is more convenient to use.

To achieve the above object, an automatic cat litter adding structure is provided according to the present disclosure, including a litter storage bin and a litter adding device.

The litter storage bin is provided with a litter bin discharge port.

The litter adding device includes a device main body, a feeding screw and a driver.

The device main body is provided with a screw cavity, and a litter adding intake port and a litter adding discharge port that are in communication with the screw cavity.

The litter bin discharge port is in communication with the litter adding intake port.

The feeding screw is mounted in the screw cavity.

The driver is connected to the feeding screw and is configured to drive the feeding screw to rotate.

Further, the litter adding device further includes a litter discharge connector and an elastic member.

The litter discharge connector is mounted to the litter adding discharge port via the elastic member, and is retractable in a discharge direction of the litter adding discharge port.

An inclined wedge part is provided at an end of an outer peripheral wall of the litter discharge connector away from the litter adding discharge port.

A surface of the inclined wedge part away from the litter adding discharge port is flush with an end face of the litter discharge connector away from the litter adding discharge port.

The inclined wedge part has a thickness that gradually decreases from one end of the inclined wedge part connected to the litter discharge connector to the other end of the inclined wedge part away from the litter discharge connector.

A litter discharge cavity of the litter discharge connector is provided with an inclined guide surface for litter discharged from the litter adding discharge port to slide down.

Further, the litter adding device further includes a litter discharge connector.

The litter discharge connector is mounted to the litter adding discharge port and is elastically deformable.

Further, the litter adding intake port is provided on an outer peripheral wall of the device main body and faces upward.

The litter storage bin is mounted to the litter adding intake port.

The litter bin discharge port is provided at a bottom of the litter storage bin.

The litter storage bin includes an upper bin section and a lower bin section connected to the upper bin section.

A bin cavity of the lower bin section gradually narrows from top to bottom.

Further, the automatic cat litter adding structure is further provided with a detection device for detecting a remaining amount of litter.

Further, a screw flight of the feeding screw has a constant or variable pitch.

Further, a screw flight of the feeding screw has a constant or variable radius.

Further, the litter adding discharge port is provided on an end face of the device main body, and an upper half of the litter adding discharge port is blocked.

The screw cavity is composed of an input cavity section and an output cavity section.

The input cavity section is in direct communication with the litter adding intake port.

The output cavity section is in direct communication with the litter adding discharge port.

The pitch of the screw flight on one section of the feeding screw located in the output cavity section is greater than the pitch of the screw flight on the other section of the feeding screw located in the input cavity section.

Further, a baffle is provided between the input cavity section and the output cavity section, and the baffle is located above the feeding screw.

Further, an end of the screw flight of the feeding screw close to the litter adding discharge port is connected with a blocking sheet that matches the litter adding discharge port.

The blocking sheet is configured to be fitted with the litter adding discharge port to close the litter adding discharge port.

Further, an end of the feeding screw extends out of the device main body and is connected to the driver.

Alternatively, an end of the feeding screw extends out of the device main body and is connected to the driver via a transmission assembly.

It can be seen from the above technical solutions that, the automatic cat litter adding structure according to the present disclosure includes the litter storage bin for storing litter and the litter adding device for conveying the litter. The litter adding device includes the device main body having the screw cavity, the feeding screw mounted in the screw cavity, and the driver for driving the feeding screw to rotate. The cat litter is pushed through the rotation of the feeding screw, thereby realizing quantitative addition of the cat litter. The cat litter adding process is smooth, without any jamming or blocking. This design enables quantitative addition of cat litter, and is more convenient to use.

### BRIEF DESCRIPTION OF THE DRAWINGS

In order to more clearly illustrate the technical solutions in the embodiments of the present disclosure or in the conventional technology, the accompanying drawings referred to in the description of the embodiments or the conventional technology are briefly described below. Obviously, the accompanying drawings in the following description merely show some embodiments of the present disclosure, and other drawings may be obtained by those skilled in the art based on these drawings without any creative effort.

FIG. 1 is a front view of an automatic cat litter adding structure according to the present disclosure without a driver;

FIG. 2 is a top view of the automatic cat litter adding structure according to the present disclosure without a driver;

FIG. 3 is a front cross-sectional view of the automatic cat litter adding structure according to the present disclosure without a driver;

FIG. 4 is a perspective cross-sectional view of the automatic cat litter adding structure according to the present disclosure without a driver;

FIG. 5 is a perspective view of a litter adding device of an automatic cat litter adding structure according to the present disclosure with a litter discharge connector;

FIG. 6 is a front view of the litter adding device of the automatic cat litter adding structure according to the present disclosure with the litter discharge connector;

FIG. 7 is a side view showing a combination of the automatic cat litter adding structure according to the present disclosure and a rotatable litter container;

FIG. 8 is a front view showing the combination of the automatic cat litter adding structure according to the present disclosure and the rotatable litter container;

FIG. 9 is a schematic structural view of the automatic cat litter adding structure according to the present disclosure where a litter discharge connector thereof is in an extended state;

FIG. 10 is a schematic structural view of the automatic cat litter adding structure according to the present disclosure where the litter discharge connector thereof is in a retracted state;

FIG. 11 is a front view of a feeding screw of an automatic cat litter adding structure according to the present disclosure which has a screw flight with variable pitch;

FIG. 12 is a perspective view of the feeding screw of the automatic cat litter adding structure according to the present disclosure which has the screw flight with variable pitch;

FIG. 13 is a front perspective view of a feeding screw of an automatic cat litter adding structure according to the present disclosure in use, which has a screw flight with variable radius;

FIG. 14 is a side perspective view of the feeding screw of the automatic cat litter adding structure according to the present disclosure in use, which has the screw flight with variable radius; and

FIG. 15 is a perspective view of the feeding screw of the automatic cat litter adding structure according to the present disclosure, which has the screw flight with variable radius.

### REFERENCE NUMERALS

| | |
|---|---|
| 100. litter storage bin; | 200. litter adding device; |
| 300. litter container; | 301. litter container intake port; |
| 10. litter bin discharge port; | 11. upper bin section; |
| 12. lower bin section; | 21. device main body; |
| 210. litter adding intake port; | 211. litter adding discharge port; |
| 212. baffle; | 213. engagement part; |
| 214. recessed hole; | 22. feeding screw; |
| 221. blocking sheet; | 23. driver; |
| 24. transmission assembly; | 31. litter discharge connector; |
| 310. inclined guide surface; | 311. stopping flange; |
| 312. limiting groove; | 313. protrusion; |
| 32. engagement part. | |

### DETAILED DESCRIPTION OF THE EMBODIMENTS

The technical solutions in the embodiments of the present disclosure will be clearly and completely described below with reference to the accompanying drawings. Obviously, the described embodiments are only some rather than all of the embodiments of the present disclosure. Based on the embodiments of the present disclosure, all other embodiments obtained by those skilled in the art without creative efforts fall within the protection scope of the present disclosure.

In the description of the embodiments of the present disclosure, it should be noted that the orientation or positional relationships indicated by the terms such as “central”, “upper”, “lower”, “left”, “right”, “vertical”, “horizontal”, “inner”, “outer” and the like are based on the orientation or positional relationships shown in the accompanying drawings, which are only for facilitating and simplifying the description of the embodiments of the present disclosure, rather than indicating or implying that the device or element referred to must have a specific orientation or be configured and operated in a particular orientation. Therefore, the above terms should not be construed as limitations to the present disclosure. In addition, terms such as “first”, “second”, “third” and the like are merely for description, and should not be construed as indicating or implying relative importance.

In the description of the embodiments of the present disclosure, it should be noted that, unless otherwise clearly specified or limited, terms such as “mounting”, “link” and “connection” should be construed in a broad sense. For example, the connection may be a fixed connection, a detachable connection or an integral connection. It may be a mechanical connection or an electrical connection. It may be a direct connection or an indirect connection through an intermediate medium, or communication between interiors of two elements. For those skilled in the art, the specific meanings of the above terms in the embodiments of the present disclosure can be understood in the light of specific conditions.

An automatic cat litter adding structure is disclosed according to an embodiment of the present disclosure.

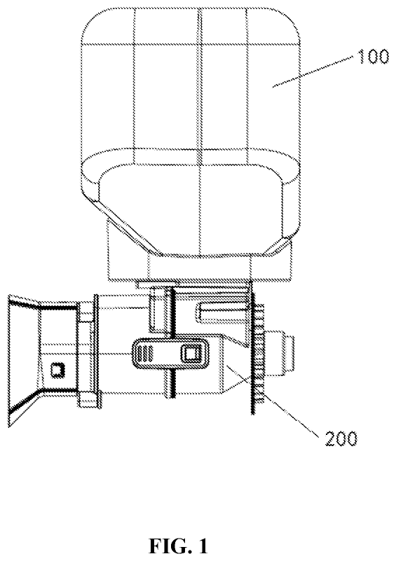

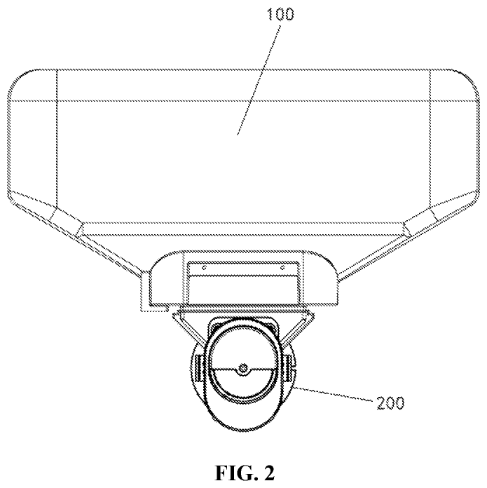

Referring to FIG. 1 to FIG. 4, an automatic cat litter adding structure according to a first embodiment of the present disclosure includes a litter storage bin 100 and a litter adding device 200.

The litter storage bin 100 is provided with a litter bin discharge port 10, and is also provided with a cat litter bin intake port to facilitate replenishment of litter into the litter storage bin 100.

The litter adding device 200 includes a device main body 21, a feeding screw 22, and a driver 23.

The device main body 21 is provided with a screw cavity, and a litter adding intake port 210 and a litter adding discharge port 211 that are in communication with the screw cavity. The structure of the device main body 21 can be changed based on the mounting and arrangement requirements, which is not limited, as long as a screw cavity for conveying the cat litter is formed inside the device main body 21.

The litter bin discharge port 10 is in communication with the litter adding intake port 210, so that the litter in the litter storage bin 100 can enter the screw cavity to be conveyed.

The feeding screw 22 is mounted in the screw cavity. The driver 23 is connected to the feeding screw 22 and is configured to drive the feeding screw 22 to rotate, so as to push the litter.

According to the present disclosure, the cat litter is pushed through the rotation of the feeding screw 22, thereby realizing quantitative addition of the cat litter. In this way, the cat litter adding process is smooth, without jamming or blocking. This design allows for quantitative addition of cat litter, and is convenient to use.

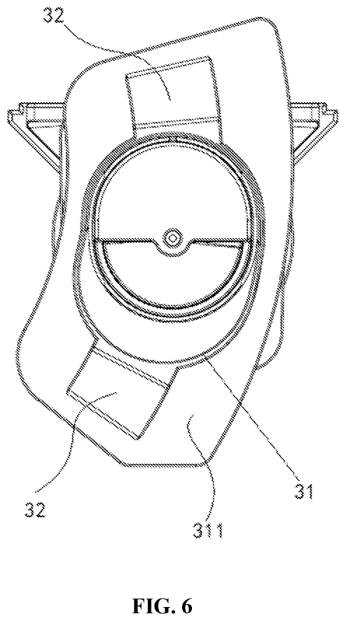

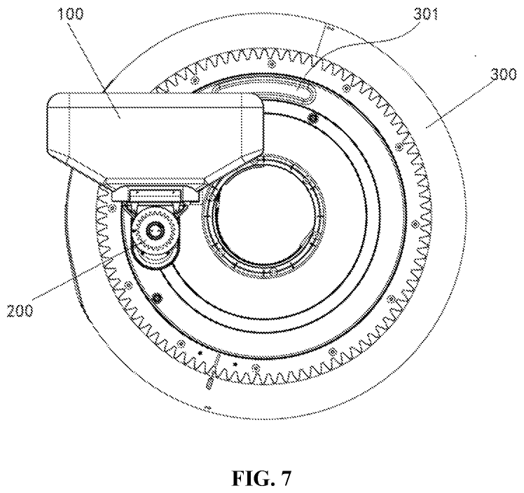

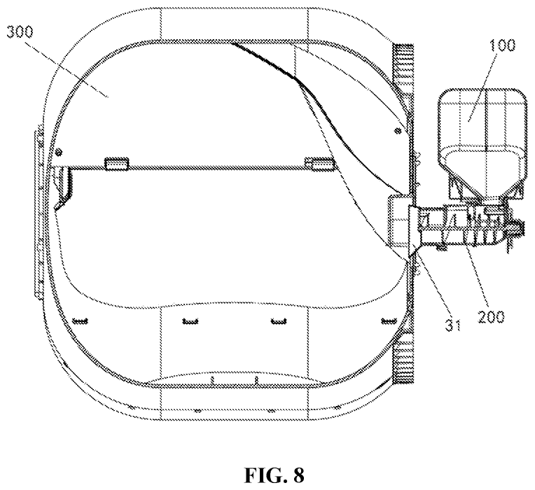

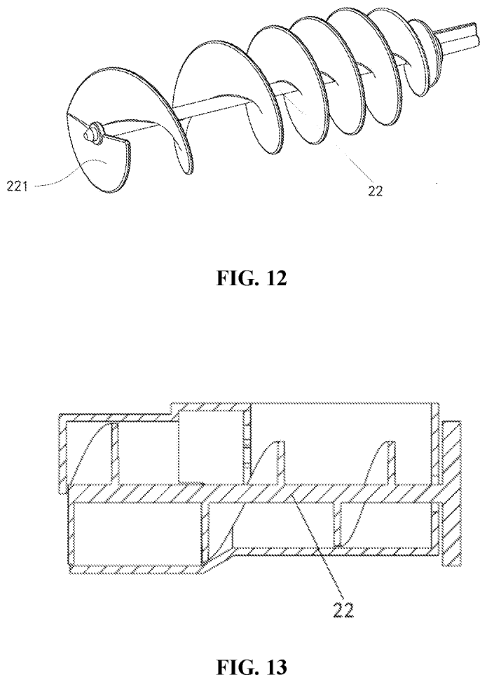

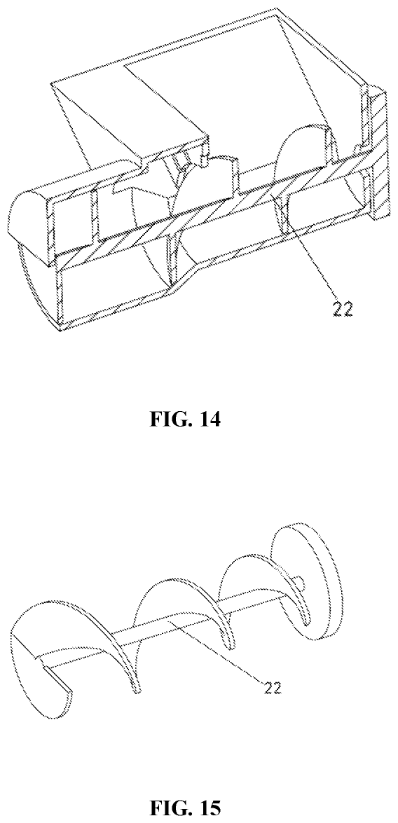

The automatic cat litter adding structure according to the first embodiment of the present disclosure is described above, and an automatic cat litter adding structure according to a second embodiment of the present disclosure is described below. Specifically, please refer to FIG. 1 to FIG. 15.

The following solutions are described based on the solutions in the first embodiment.

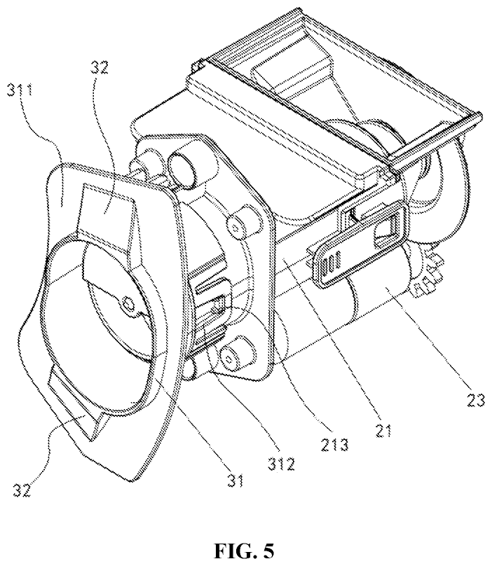

As shown in FIG. 5 to FIG. 8, further, since some smart litter containers 300 are designed to be rotatable or movable, the litter adding device 200 according to the present disclosure further includes a litter discharge connector 31 and an elastic member (not shown in the drawings) to be better combined with these litter containers 300 without affecting the rotations or movements of the litter containers 300.

The litter discharge connector 31 is mounted to the litter adding discharge port 211 via the elastic member, and is retractable in a discharge direction of the litter adding discharge port 211. An inclined wedge part is provided at an end of an outer peripheral wall of the litter discharge connector 31 away from the litter adding discharge port 211. A surface of the inclined wedge part away from the litter adding discharge port 211 is flush with an end face of the litter discharge connector 31 away from the litter adding discharge port 211, and the inclined wedge part has a thickness gradually decreasing from one end of the inclined wedge part connected to the litter discharge connector 31 to the other end of the inclined wedge part away from the litter discharge connector 31. The inclined wedge part can contact the litter container 300 and move relative to the litter container 300 when the litter container 300 is rotated or moved, so that the litter discharge connector 31 is retracted to avoid affecting the rotation or movement of the litter container 300. When the litter container 300 is rotated or moved to a position where the litter discharge connector 31 is aligned with a litter container intake port 301 of the litter container 300, the litter discharge connector 31 can be engaged into the litter container intake port 301 under the action of the elastic member. At this time, the driver 23 can be activated, so that cat litter can be added into the litter container 300. When the litter container 300 is rotated or moved, it can come into contact with the inclined wedge part to retract the litter discharge connector 31 again. This design allows for automatic alignment without affecting the rotation or movement of the smart litter container 300, such that the cat litter adding process is smooth, leading to better applicability. In the present disclosure, there may be two inclined wedge parts. For example, the litter container 300 is designed to be rotatable. The two inclined wedge parts are distributed on both sides of an end part of the litter discharge connector 31 along a rotation trajectory of the litter container intake port 301 of the litter container 300, so that the litter discharge connector 31 can be retracted regardless of whether the litter container 300 is rotated forward or backward. The outer peripheral wall of the litter discharge connector 31 is further provided with a stopping flange 311 around the outer peripheral wall, which is in contact with and abuts against an edge of the litter container intake port 301, so as to improve the cooperation between the litter discharge connector 31 and the litter container intake port 301. Correspondingly, the inclined wedge parts may be arranged at a junction between the stopping flange 311 and the outer peripheral wall of the litter discharge connector 31.

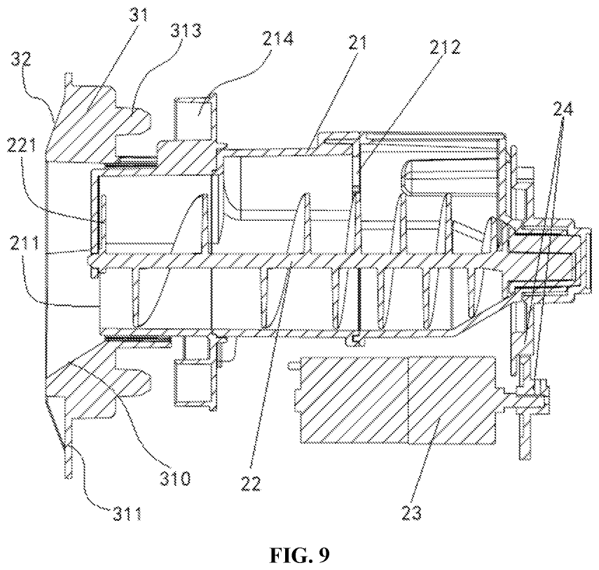

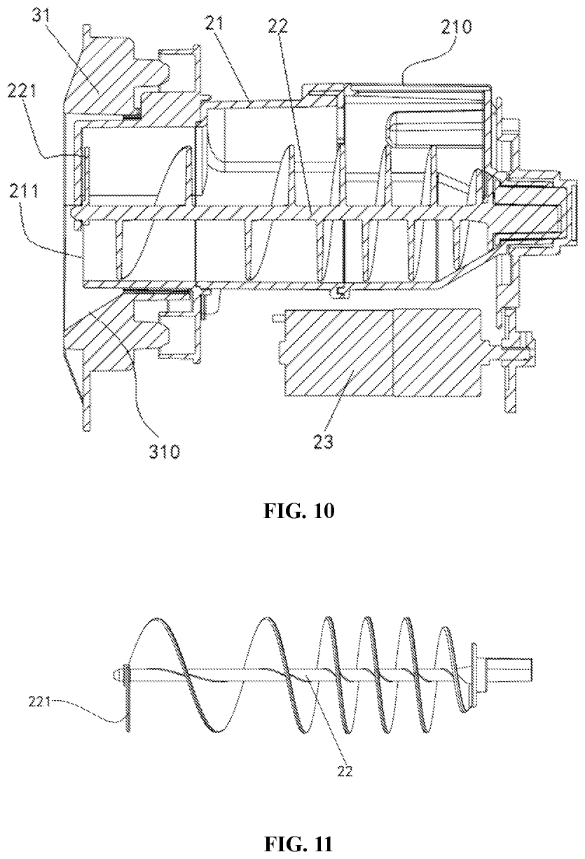

As shown in FIG. 9 and FIG. 10, the elastic member may be a spring, and the elastic connection of the elastic member may be realized in the following way. A protrusion 313 is provided on the litter discharge connector 31, and the device main body 21 is provided with a recessed hole 214 for the protrusion 313 to movably extend into. The elastic member is arranged around the protrusion 313, one end of the elastic member is in contact with and abuts against the litter discharge connector 31, and the other end of the elastic member is in contact with and abuts against a bottom of the recessed hole 214. The litter discharge connector 31 is movably arranged on an end of the device main body 21 provided with the litter adding discharge port 211, and the litter discharge connector 31 is provided with a limiting groove 312. The device main body 21 is provided with an engagement part 32213, which is engaged in the limiting groove 312 and is slidable along the limiting groove 312, so that the litter discharge connector 31 is retractable on the device main body 21 through the cooperation between the engagement part 32213 and the limiting groove 312.

As shown in FIG. 9 and FIG. 10, in addition, in order to ensure the smooth discharge of the litter in the litter discharge connector 31, a litter discharge cavity of the litter discharge connector 31 is provided with an inclined guide surface 310 for the litter discharged from the litter adding discharge port 211 to slide down. In this way, the litter discharged from the litter adding discharge port 211 can slide into the litter container 300 along the inclined guide surface 310. When the litter in the screw cavity is conveyed, the litter in the litter storage bin 100 will naturally slide down to fill the screw cavity, thereby realizing continuous automatic cat litter adding.

Further, the elastic member may not be provided. In this case, specifically, the litter adding device 200 further includes a litter discharge connector 31, which is mounted to the litter adding discharge port 211 and is elastically deformable. That is, the litter discharge connector 31 is flexible and has elastic deformability, and it may be made of rubber, silica gel and other materials. In this way, the litter discharge connector 31 can also be combined with the litter container 300 without affecting the rotation or movement of the litter container 300.

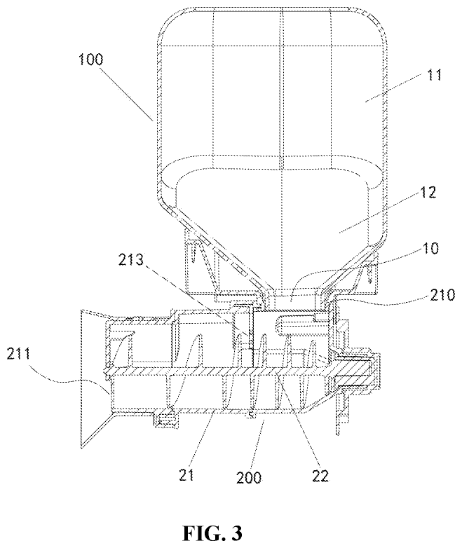

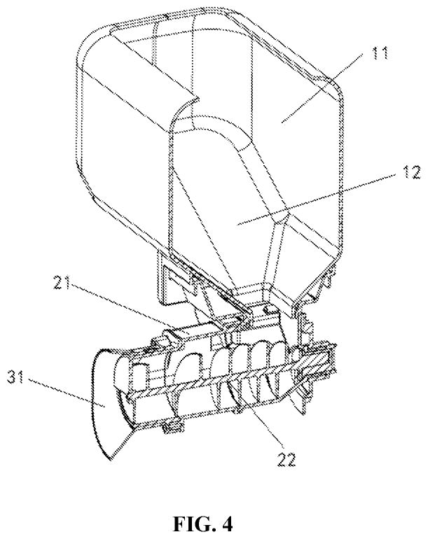

Further, as shown in FIG. 3 and FIG. 4, the litter adding intake port 210 is provided on an outer peripheral wall of the device main body 21 and faces upward. Correspondingly, the litter storage bin 100 can be directly mounted to the litter adding intake port 210, and the litter bin discharge port 10 is provided at a bottom of the litter storage bin 100. With this design, the arrangements of the corresponding communication pipes can be reduced, and the overall structure is also more compact. Moreover, the litter in the litter storage bin 100 can be discharged under its own gravity without requiring an auxiliary discharge device. The litter slides down to the screw cavity through a lower bin section 12, and the driver 23 drives the feeding screw 22 to rotate, so that the litter is pushed to the litter adding discharge port 211. Then the litter slides into the litter container 300 via the inclined guide surface 310 of the litter discharge connector 31.

The litter storage bin 100 is designed in a funnel structure, and includes an upper bin section 11 and a lower bin section 12 connected to the upper bin section 11. A bin cavity of the lower bin section 12 gradually narrows from top to bottom, so that the litter can slide down to the screw cavity more smoothly. The litter storage bin 100 is divided into the upper and lower sections in design, and only the lower section narrows, which ensures smooth litter discharge while avoiding excessive reduction of the storage capacity of the litter storage bin 100. Certainly, the whole bin cavity of the litter storage bin 100 may be designed to gradually narrow from top to bottom, which is not limited herein. The design of the bin cavity of the lower bin section 12 is not limited, as long as at least one inner wall of the bin cavity of the lower bin section 12 is designed to be inclined or curved to achieve the gradually narrowing design of the bin cavity, which is not limited herein.

Further, in the present disclosure, the automatic cat litter adding structure is further provided with a detection device (not shown in the drawings) for detecting a remaining amount of the litter. Specifically, the detection device for detecting the remaining amount of the litter is provided at the bottom of the litter storage bin 100. The detection device may be an infrared sensor, a laser sensor, an electrode sheet sensor, a pressure sensor, a mechanical switch, a current detector, etc., which is not limited herein. Through this design, the remaining amount of the litter in the litter storage bin 100 can be checked. When a control system determines that the remaining amount of the litter is insufficient based on data detected by the detection sensor, the control system can issue an alarm signal to facilitate the timely replenishment of the litter.

Further, a screw flight of the feeding screw 22 may be designed to have a constant or variable pitch. The specific design may be varied based on actual needs and will not be limited herein.

Further, a screw flight of the feeding screw 22 may be designed to have a constant or variable radius. The specific design may be varied based on actual needs and will not be limited herein. FIG. 13 to FIG. 15 show an application of a screw flight of the feeding screw 22 with a variable radius, and details will not be described herein.

Further, as shown in FIG. 9 and FIG. 10, in an example, the litter adding discharge port 211 is provided on an end face of the device main body 21, and an upper half of the litter adding discharge port 211 is blocked. That is, a lower half of the litter adding discharge port 211 is opened. In this case, the screw flight of the feeding screw 22 may be designed to have a variable pitch.

Specifically, the screw cavity is designed to be composed of an input cavity section and an output cavity section. The input cavity section is in direct communication with the litter adding intake port 210, and the output cavity section is in direct communication with the litter adding discharge port 211. It is understandable that the litter adding intake port 210 is provided at a position corresponding to the input cavity section, and the litter adding discharge port 211 is provided at a position corresponding to the output cavity section.

As shown in FIG. 10 to FIG. 12, the pitch of the screw flight on one section of the feeding screw 22 located in the output cavity section is designed to be greater than the pitch of the screw flight on the other section of the feeding screw 22 located in the input cavity section, and is at least twice the pitch of the screw flight on the other section of the feeding screw 22 located in the input cavity section. Since the pitch of the screw flight in the output cavity section is at least twice the pitch of the screw flight in the input cavity section, when the litter moves into the output cavity section, the cross-sectional area of the litter is less than half of that in the input cavity section. At this time, the litter corresponds to the opening at the lower half of the litter adding discharge port 211, and can be smoothly conveyed to the litter adding discharge port 211 without jamming, thereby ensuring smooth litter discharge.

Further, as shown in FIG. 9 and FIG. 10, a baffle 212 is provided between the input cavity section and the output cavity section and is located above the feeding screw 22. The baffle 212 can block the litter falling into the input cavity section, so as to limit the amount of the litter falling from the litter storage bin 100, and prevent the litter falling into the input cavity section from escaping into the output cavity section, thereby achieving accurate control of litter conveying.

Further, as shown in FIG. 9 to FIG. 12, an end of the screw flight of the feeding screw 22 close to the litter adding discharge port 211 is connected with a blocking sheet 221 that matches the litter adding discharge port 211. The blocking sheet 221 can be fitted with the litter adding discharge port 211 to close the litter adding discharge port 211. After cat litter adding, the feeding screw 22 is driven until the blocking sheet 221 reaches the litter adding discharge port 211 to block the litter adding discharge port 211, thereby preventing the litter from further coming out.

In the present disclosure, when the feeding screw 22 conveys the litter, the litter conveying capacity of the feeding screw 22 is constant. Therefore, it is possible to control the litter adding amount by controlling the number of rotations of the feeding screw 22.

Further, an end of the feeding screw 22 extends out of the device main body 21 and is coaxially connected to the driver 23. That is, the driver 23 is directly connected to the feeding screw 22 via a coupling to drive the feeding screw 22 to rotate.

Certainly, as shown in FIG. 9, alternatively, an end of the feeding screw 22 extends out of the device main body 21 and is connected to the driver 23 via a transmission assembly 24, which may be a gear transmission assembly. In this way, the driver 23 may be arranged below or at a lateral side of the device main body 21, thereby saving space and making the overall structure more compact.

In the present disclosure, the driver 23 may be a conventional servo motor, which is not limited herein.

The automatic cat litter adding structure according to the present disclosure is described in detail above. For those skilled in the art, modification may be made to the specific embodiments and the application scope based on the concept of the embodiments of the present disclosure. In summary, the content of the specification should not be construed as limitation to the present application.

1. An automatic cat litter adding structure, comprising:
a litter storage bin; and
a litter adding device, wherein
the litter storage bin is provided with a litter bin discharge port;
the litter adding device comprises a device main body, a feeding screw and a driver;
the device main body is provided with a screw cavity, and a litter adding intake port and a litter adding discharge port that are in communication with the screw cavity;
the litter bin discharge port is in communication with the litter adding intake port;
the feeding screw is mounted in the screw cavity; and
the driver is connected to the feeding screw and is configured to drive the feeding screw to rotate.

2. The automatic cat litter adding structure according to claim 1, wherein
the litter adding device further comprises a litter discharge connector and an elastic member;
the litter discharge connector is mounted to the litter adding discharge port via the elastic member, and is retractable in a discharge direction of the litter adding discharge port;
an inclined wedge part is provided at an end of an outer peripheral wall of the litter discharge connector away from the litter adding discharge port;
a surface of the inclined wedge part away from the litter adding discharge port is flush with an end face of the litter discharge connector away from the litter adding discharge port;
the inclined wedge part has a thickness that gradually decreases from one end of the inclined wedge part connected to the litter discharge connector to the other end of the inclined wedge part away from the litter discharge connector; and
a litter discharge cavity of the litter discharge connector is provided with an inclined guide surface for litter discharged from the litter adding discharge port to slide down.

3. The automatic cat litter adding structure according to claim 1, wherein
the litter adding device further comprises a litter discharge connector; and
the litter discharge connector is mounted to the litter adding discharge port and is elastically deformable.

4. The automatic cat litter adding structure according to claim 1, wherein
the litter adding intake port is provided on an outer peripheral wall of the device main body and faces upward;
the litter storage bin is mounted to the litter adding intake port;
the litter bin discharge port is provided at a bottom of the litter storage bin;
the litter storage bin comprises an upper bin section and a lower bin section connected to the upper bin section; and
a bin cavity of the lower bin section gradually narrows from top to bottom.

5. The automatic cat litter adding structure according to claim 1, wherein the automatic cat litter adding structure is further provided with a detection device for detecting a remaining amount of litter.

6. The automatic cat litter adding structure according to claim 1, wherein a screw flight of the feeding screw has a constant or variable pitch.

7. The automatic cat litter adding structure according to claim 1, wherein a screw flight of the feeding screw has a constant or variable radius.

8. The automatic cat litter adding structure according to claim 6, wherein the litter adding discharge port is provided on an end face of the device main body, and an upper half of the litter adding discharge port is blocked;
the screw cavity is composed of an input cavity section and an output cavity section;
the input cavity section is in direct communication with the litter adding intake port;
the output cavity section is in direct communication with the litter adding discharge port; and
the pitch of the screw flight on one section of the feeding screw located in the output cavity section is greater than the pitch of the screw flight on the other section of the feeding screw located in the input cavity section.

9. The automatic cat litter adding structure according to claim 8, wherein a baffle is provided between the input cavity section and the output cavity section, and the baffle is located above the feeding screw.

10. The automatic cat litter adding structure according to claim 8, wherein
an end of the screw flight of the feeding screw close to the litter adding discharge port is connected with a blocking sheet that matches the litter adding discharge port; and
the blocking sheet is configured to be fitted with the litter adding discharge port to close the litter adding discharge port.

11. The automatic cat litter adding structure according to claim 1, wherein
an end of the feeding screw extends out of the device main body and is connected to the driver; or
an end of the feeding screw extends out of the device main body and is connected to the driver via a transmission assembly.
